(19) United States
(12) Patent Application Publication
(10) Pub. No.: US 2016/0035528 A1
(43) Pub. Date: Feb. 4, 2016

(54) FUSE UNIT

(71) Applicant: YAZAKI CORPORATION, Minato-ku, Tokyo (JP)

(72) Inventors: Motofumi KATO, Shizuoka (JP); Tatsuya AOKI, Shizuoka (JP)

(73) Assignee: YAZAKI CORPORATION, Tokyo (JP)

(21) Appl. No.: 14/758,688

(22) PCT Filed: Jan. 14, 2014
(86) PCT No.: PCT/JP2014/050432

§ 371 Date: Jun. 30, 2015

(30) Foreign Application Priority Data
Jan. 16, 2013 (JP) 2013-005644

(51) Int. Cl. H01H 85/20

(52) U.S. Cl. CPC H01H 85/204

(57) ABSTRACT

Between a first housing 20 made of resin which supports a first terminal fitting 10 coupled to a battery terminal and a second housing 60 which supports a second terminal fitting 40 to which a wire harness 30 is coupled and has a fuse mounting hole 61, a communication-plate portion 13, which is integrally formed in the first terminal fitting 10 and bendable in the thickness direction, is exposed. The direction of the second housing 60 is adjustable by bending the communication-plate portion 13. This ensures the compatibility between improvement in visibility for a blade type fuse and improvement in routing property of a wire harness.

### FIELD

The present invention relates to a fuse unit for coupling a wire harness laid at a vehicle to an in-vehicle battery via a blade type fuse.

### BACKGROUND

As the above-described fuse unit, there are proposed various fuse units where a battery coupling portion coupled to a battery, a harness coupling portion for coupling a wire harness, and a fuse mounting hole for mounting a blade type fuse are arranged to be secured on one resin-made housing (for example, see Patent Literature 1 below).

### CITATION LIST

### Patent Literature

Patent Literature 1: Japanese Patent Application Laid-open No. 2012-3904

### SUMMARY

### Technical Problem

Meanwhile, the blade type fuse has a structure where a resin housing accommodates base end portions of a pair of blades and a meltable portion coupling between these base end portions. On the top portion of the resin housing, a transparent window portion for viewing the condition of the meltable portion is arranged. However, since the rating is also indicated (printed) on the top portion of the resin-made housing, it might be hard to view the meltable portion depending on the angle for viewing. In the conventional fuse unit, in the case where it is hard to view the meltable portion, the direction of the fuse mounting hole itself cannot be adjusted. Accordingly, the blade type fuse has to be removed for checking and there is a problem of poor handling property.

On the other hand, for ease of viewing the meltable portion of the blade type fuse, when the arrangement in the resin-made housing is designed while priority is given to the position of the fuse mounting hole, the arrangement of the harness coupling portion is limited. Thus, the routability of the wire harness might be reduced.

Therefore, in order to solve the above-described problem, it is an object of the present invention to provide a fuse unit that ensures the compatibility between improvement in visibility for the blade type fuse and improvement in routing property of the wire harness.

### Solution to Problem

The above-described object of the present invention is achieved by the following configuration.

(1) A fuse unit includes:

a first terminal fitting configured to be integrally formed of a metal plate and include a battery coupling plate portion coupled to a battery terminal, a first blade-sandwiching-plate portion that fits one blade of a blade type fuse, and a communication-plate portion that communicates between the battery coupling plate portion and the first blade-sandwiching-plate portion and is bendable in a thickness direction;

a first housing made of resin configured to accommodate and support the battery coupling plate portion such that the communication-plate portion and the first blade-sandwiching-plate portion in the first terminal fitting are exposed to outside;

a second terminal fitting configured to be integrally formed of a metal plate and include a harness coupling portion to which a wire harness is to be coupled, and a second blade-sandwiching-plate portion that continues into the harness coupling portion and fits another blade of the blade type fuse; and

a second housing made of resin configured to have a fuse mounting hole on which the blade type fuse is mounted, support the first blade-sandwiching-plate portion and the second blade-sandwiching-plate portion within the fuse mounting hole, and couple the first blade-sandwiching-plate portion and the second blade-sandwiching-plate portion together via the blade type fuse, wherein

a direction of the second housing with respect to the first housing is adjustable by bending the communication-plate portion exposed between the first housing and the second housing.

With the configuration according to (1) described above, in this fuse unit, the battery coupling plate portion is secured to the battery terminal of an in-vehicle battery and then the wire harness is coupled to the harness coupling portion of the second terminal fitting supported by the second housing, so as to obtain the state where the wire harness is coupled to the battery via the blade type fuse.

When the wire harness is coupled to the harness coupling portion of the second terminal fitting, the communication-plate portion can be bended as necessary so as to adjust the direction of the harness coupling portion supported by the second housing to the direction that facilitates coupling of the wire harness. Accordingly, the routing property of the wire harness can be improved.

Here, when the wire harness is coupled to the harness coupling portion of the second terminal fitting, it is preferred to give an extra length to the wire harness so as to adjust the bending state of the communication-plate portion after the wire harness is coupled.

In the case where it is difficult to view the meltable portion in the blade type fuse on this fuse unit secured to the battery, the extra length of the wire harness can be used to adjust the bending state of the communication-plate portion so as to change the direction of the fuse mounting hole provided at the second housing into the direction at an angle at which the meltable portion is easily viewed. Accordingly, the visibility for the blade type fuse can also be improved.

That is, the configuration according to (1) described above ensures the compatibility between improvement in visibility for the blade type fuse and improvement in routing property of the wire harness.

The present invention has been briefly described. The detailed configurations of the present invention will be further clarified by reading the following illustrative embodiments for implementing the present invention (hereinafter referred to as “embodiments”) with reference to the accompanying drawings.

### Advantageous Effects of Invention

The fuse unit according to the present invention ensures the compatibility between improvement in visibility for the blade type fuse and improvement in routing property of the wire harness.

### BRIEF DESCRIPTION OF DRAWINGS

FIG. 1 is a perspective view of one embodiment of a fuse unit according to the present invention.

FIG. 2 is a perspective view of the state where a communication-plate portion is bended at a right angle from the state where illustrated in FIG. 1 so as to change the direction of a fuse mounting hole by 90°.

### DESCRIPTION OF EMBODIMENTS

Preferred embodiments of a fuse unit according to the present invention will be described in detail below with reference to the drawings.

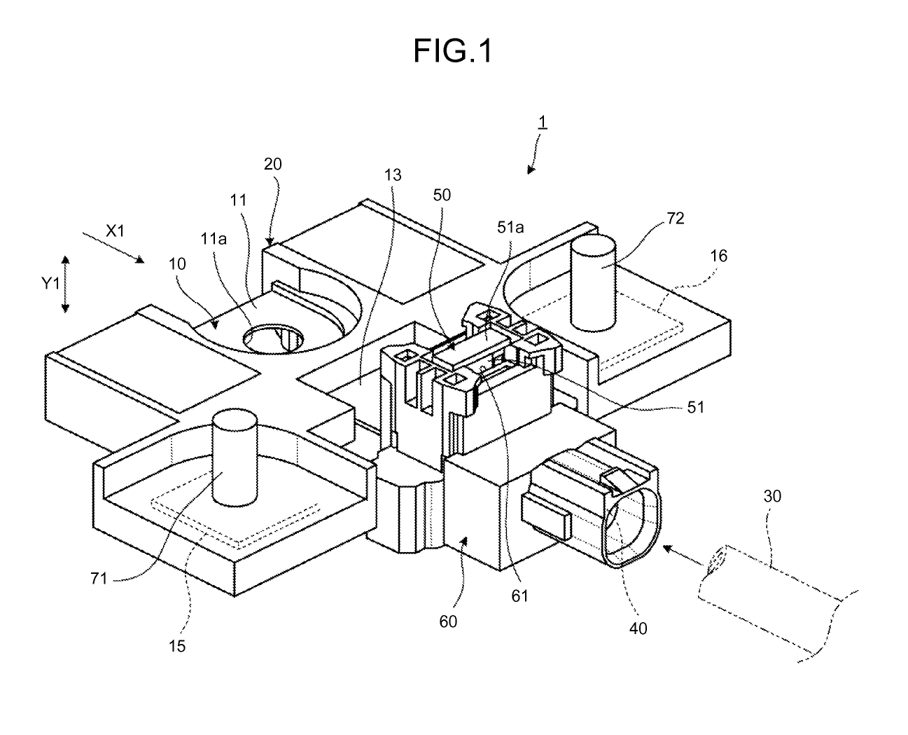

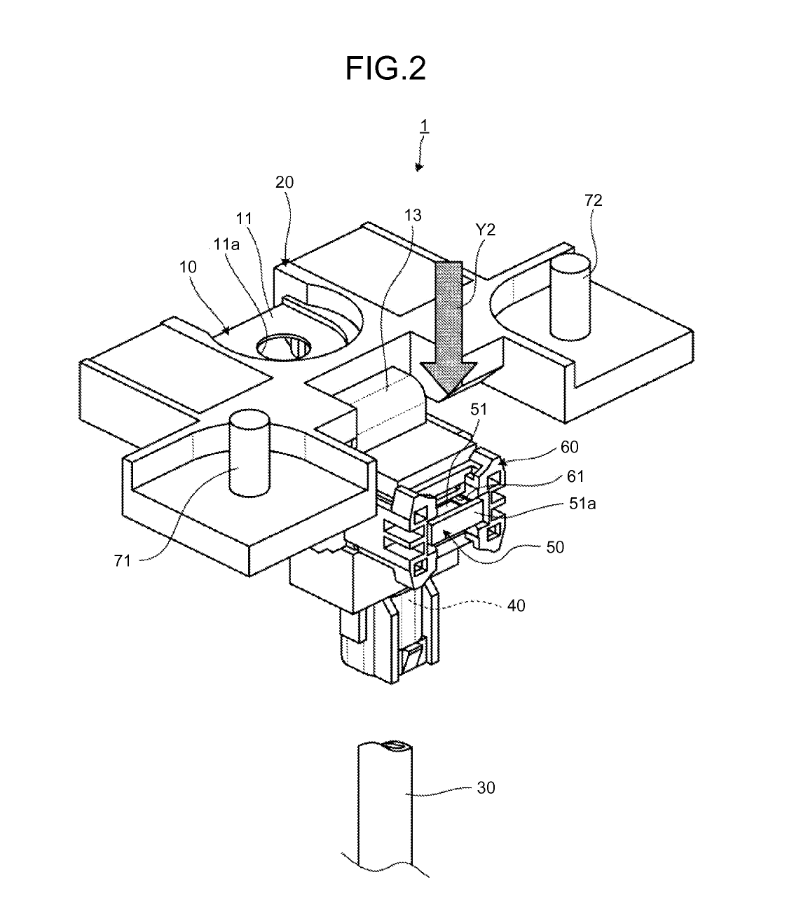

FIG. 1 is a perspective view of one embodiment of the fuse unit according to the present invention. FIG. 2 is a perspective view of the state where a communication-plate portion is bended at a right angle from the state where illustrated in FIG. 1 so as to change the direction of a fuse mounting hole by 90°.

A fuse unit 1 according to this one embodiment is a direct-mount type fuse unit, which is directly mounted on a battery terminal (not illustrated) of an in-vehicle battery. The fuse unit 1 includes: a first terminal fitting 10 coupled to the battery terminal; a first housing made of resin 20, which accommodates and supports a part of this first terminal fitting 10; a second terminal fitting 40 to which a wire harness 30 laid at the vehicle is coupled; and a second housing made of resin 60, which supports a part of the first terminal fitting 10 and the second terminal fitting 40 and on which a blade type fuse 50 is mounted.

The first terminal fitting 10 is a terminal fitting integrally formed of a metal plate. The first terminal fitting 10 includes: a battery coupling plate portion 11 to be coupled to a battery terminal (not illustrated); a first blade-sandwiching-plate portion, which fits one blade of the blade type fuse 50; and a communication-plate portion 13, which communicates between the battery coupling plate portion 11 and the first blade-sandwiching-plate portion.

In the battery coupling plate portion 11, a mounting hole 11a for screwing on the battery terminal is formed to penetrate. Also in the battery coupling plate portion 11, circuit coupling plate portions 15 and 16 where bolts 71 and 72 for coupling terminals are implanted are integrally formed.

On the bolts 71 and 72 for coupling terminals, for example, power feeding cables to in-vehicle electrical components such as an alternator are screwed via ring terminals crimped on the ends of these power feeding cables.

The communication-plate portion 13 has a band plate shape, and extends in the direction indicated by an arrow X1 in FIG. 1 from the battery coupling plate portion 11 in a non-bended state. The plate thickness of this communication-plate portion 13 is set to have the strength to the extent that the worker can bend the communication-plate portion 13 by hand. The communication-plate portion 13 can be bended in the thickness direction (an arrow Y1 direction in FIG. 1). In the distal end portion of this communication-plate portion 13, the first blade-sandwiching-plate portion (not illustrated) is integrally formed.

The first housing 20 accommodates and supports the battery coupling plate portion 11 and the circuit coupling plate portions 15 and 16 such that the communication-plate portion 13 and the first blade-sandwiching-plate portion in the first terminal fitting 10 are exposed to outside.

The second terminal fitting 40 is integrally formed of a metal plate. While not illustrated, this second terminal fitting 40 includes: a harness coupling portion to which the wire harness 30 is coupled; and a second blade-sandwiching-plate portion, which continues into this harness coupling portion and fits the other blade of the blade type fuse 50.

The blade type fuse 50 has the structure that includes: a pair of blades arrayed in parallel on the identical plane; a meltable portion, which couples between the base end portions of these blades; and a resin housing 51, which accommodates and supports the meltable portion and the base end portions of the pair of blades. On a top portion 51a of the resin housing 51, a transparent window portion (not illustrated) for viewing the condition of the meltable portion is arranged. On the top portion 51a of the resin housing 51, the rating is indicated side by side with the transparent window portion (not illustrated).

The second housing 60 has a fuse mounting hole 61 on which the blade type fuse 50 is mounted. The second housing 60 supports the first blade-sandwiching-plate portion and the second blade-sandwiching-plate portion within the fuse mounting hole 61. Mounting the blade type fuse 50 on the fuse mounting hole 61 couples the first blade-sandwiching-plate portion and the second blade-sandwiching-plate portion together via the blade type fuse 50.

In the fuse unit 1 described above, the direction of the second housing 60 with respect to the first housing 20 can be adjusted by bending the communication-plate portion 13 exposed between the first housing 20 and the second housing 60.

In FIG. 2, by bending the communication-plate portion 13 in the direction indicated by an arrow Y2, the direction of the fuse mounting hole 61 is changed by 90° from the initial direction illustrated in FIG. 1.

Here, the bending angle of the communication-plate portion 13 can be set to any angle within 90° in the arrow Y2 direction in FIG. 2, and can also be set to any angle within 90° in the reverse direction of the arrow Y2 in FIG. 2 unless the second housing 60 interferes.

In the case of the fuse unit 1 according to the one embodiment described above, the battery coupling plate portion 11 is secured to the battery terminal of an in-vehicle battery and then the wire harness 30 is coupled to the harness coupling portion of the second terminal fitting 40 supported by the second housing 60, so as to obtain the state where the wire harness 30 is coupled to the battery via the blade type fuse 50.

When the wire harness 30 is coupled to the harness coupling portion of the second terminal fitting 40, the communication-plate portion 13 can be bended appropriately so as to adjust the direction of the harness coupling portion supported by the second housing 60 to the direction that facilitates coupling of the wire harness 30. Accordingly, the routing property of the wire harness 30 can be improved.

Here, when the wire harness 30 is coupled to the harness coupling portion of the second terminal fitting 40, it is preferred to give an extra length to the wire harness 30 so as to adjust the bending state of the communication-plate portion 13 after the wire harness 30 is coupled.

In the case where it is difficult to view the meltable portion in the blade type fuse 50 on the fuse unit 1 secured to the battery, the extra length of the wire harness 30 can be used to adjust the bending state of the communication-plate portion 13 so as to change the direction of the fuse mounting hole 61 provided at the second housing 60 into the direction at an angle at which the meltable portion is easily viewed. Accordingly, the visibility for the blade type fuse 50 can also be improved.

That is, the configuration according to the above-described embodiment ensures the compatibility between improvement in visibility for the blade type fuse 50 and improvement in routing property of the wire harness 30.

In the meantime, the present invention is not limited to the above illustrative embodiment and can be appropriately, for example, modified and improved. In addition, the materials, shapes, sizes, the number, the arranging places and the like of the respective constitutional elements of the above illustrative embodiment are arbitrary and are not particularly limited insomuch as the present invention can be achieved.

For example, in the case where the wire harnesses 30 for a plurality of systems are coupled to the battery, a plurality of the communication-plate portions 13 may be arranged side by side with one another in the first terminal fitting 10 and the second housing 60 may be provided for each of the communication-plate portions 13.

Now, brief summaries of characteristics of the above-described embodiment of the fuse unit according to the present invention will be listed in the following paragraph [1].

[1] A fuse unit (1) includes:

a first terminal fitting (10)configured to be integrally formed of a metal plate and include a battery coupling plate portion (11) coupled to a battery terminal,

a first blade-sandwiching-plate portion that fits one blade of a blade type fuse (50), and a communication-plate portion (13) that communicates between the battery coupling plate portion (11) and the first blade-sandwiching-plate portion and is bendable in a thickness direction;

a first housing made of resin (20) configured to accommodate and support the battery coupling plate portion (11) such that the communication-plate portion (13) and the first blade-sandwiching-plate portion in the first terminal fitting (10) are exposed to outside;

a second terminal fitting (40) configured to be integrally formed of a metal plate and include a harness coupling portion to which a wire harness (30) is to be coupled, and a second blade-sandwiching-plate portion that continues into the harness coupling portion and fits another blade of the blade type fuse (50); and

a second housing made of resin (60) configured to have a fuse mounting hole (61) on which the blade type fuse (50) is mounted, support the first blade-sandwiching-plate portion and the second blade-sandwiching-plate portion within the fuse mounting hole (61), and couple the first blade-sandwiching-plate portion and the second blade-sandwiching-plate portion together via the blade type fuse (50), wherein

a direction of the second housing (60) with respect to the first housing (20) is adjustable by bending the communication-plate portion (13) exposed between the first housing (20) and the second housing (60).

### REFERENCE SIGNS LIST

1 fuse unit

10 first terminal fitting

11 battery coupling plate portion

13 communication-plate portion

20 first housing

30 wire harness

40 second terminal fitting

50 blade type fuse

60 second housing

61 fuse mounting hole

1. A fuse unit comprising:
a first terminal fitting configured to be integrally formed of a metal plate and include a battery coupling plate portion coupled to a battery terminal, a first blade-sandwiching-plate portion that fits one blade of a blade type fuse, and a communication-plate portion that communicates between the battery coupling plate portion and the first blade-sandwiching-plate portion and is bendable in a thickness direction;
a first housing made of resin configured to accommodate and support the battery coupling plate portion such that the communication-plate portion and the first blade-sandwiching-plate portion in the first terminal fitting are exposed to outside;
a second terminal fitting configured to be integrally formed of a metal plate and include a harness coupling portion to which a wire harness is to be coupled, and a second blade-sandwiching-plate portion that continues into the harness coupling portion and fits another blade of the blade type fuse; and
a second housing made of resin configured to have a fuse mounting hole on which the blade type fuse is mounted, support the first blade-sandwiching-plate portion and the second blade-sandwiching-plate portion within the fuse mounting hole, and couple the first blade-sandwiching-plate portion and the second blade-sandwiching-plate portion together via the blade type fuse, wherein
a direction of the second housing with respect to the first housing is adjustable by bending the communication-plate portion exposed between the first housing and the second housing.
